(19) United States
(12) Patent Application Publication
(10) Pub. No.: US 2005/0197219 A1
(43) Pub. Date: Sep. 8, 2005

(54) System and method for making a customized cushioned grip on a handle

(76) Inventor: Joseph G. Casasanta JR., Auburn, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(21) Appl. No.: 10/795,493

(22) Filed: Mar. 8, 2004

(51) Int. Cl. B32B 31/00; A63B 59/12

(52) U.S. Cl. 473/560; 156/63; 156/187; 156/192; 156/265

(57) ABSTRACT

Described are a system and method for forming a custom-design grip on a handle for a sports stick or for equipment. A sheet of resilient, compressible material has a plurality of differently shaped cut-outs formed therein. Cut-out shapes include rectangles, stars, Xs, donuts, zigzags, and curves. A user selects a combination of the cut-outs for the grip design, removing them from the sheet and attaching them to one of the surfaces of the handle. Tape is then wrapped around the handle over the cut-outs to form raised impressions on the handle. The raised impressions have the shapes of the cut-outs, thus providing a customized ornamental appearance in addition to a tactile feel for a firm grasp of the handle.

### FIELD OF THE INVENTION

The invention relates generally to grips for equipment and sport sticks. More particularly, the invention relates to a system and method for making customized grips on the handles of such equipment and sports sticks.

### BACKGROUND

Many players tape their own grips on their hockey sticks. One common technique for forming a grip involves spinning a roll of self-adhesive tape into a long, twisted strip and then helically wrapping the strip around the shaft of the hockey stick at the grip end. Then the player wraps the self-adhesive tape around the shaft over the twisted strip. Covered by the tape, the twisted strip forms raised ridges along the shaft that help keep the hand of the player from sliding off of the taped grip end. These raised ridges, however, can be uncomfortable to a bare hand. Further, the appearance of the grip lacks originality and can often be aesthetically unappealing.

### SUMMARY

In one aspect, the invention features a method for forming a grip on a handle. A cut-out made of resilient, compressible material is provided. The cut-out has an adhesive surface. The adhesive surface of the cut-out is adhered to a surface of the handle. Tape is wrapped around the handle over the cut-out to form a raised impression on the handle that has a shape of the cut-out.

A system for making a customized grip on a handle. The system includes a handle having a plurality of surfaces. Differently shaped cut-outs of resilient, compressible material with an adhesive backing are adhered to one of the surfaces of the handle. A self-adhesive tape is wrapped around the handle over the cut-outs of resilient material to produce a grip having resilient, compressible raised impressions in the shapes of the cut-outs.

In another aspect, the invention features a hockey stick having a handle. The hockey stick includes a plurality of differently shaped cut-outs of resilient, compressible material adhered to at least one surface of the handle. Tape is wrapped spirally around the shaft over the cut-outs to produce a grip on the handle having resilient, compressible raised impressions in the shapes of the cut-outs.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a diagram of an embodiment of a sheet made of soft, resilient, compressible material for use in customized construction of handle grips in accordance with the principles of the invention.

FIG. 2 is a diagram of an embodiment of a process for making a custom grip in accordance with the principles of the invention.

FIG. 3A is a view of an embodiment of a custom-design grip for a shaft or stick constructed in accordance with the invention.

FIG. 3B is a view of another side of the embodiment of the custom-design grip of FIG. 3A.

### DETAILED DESCRIPTION

The present invention features a system and method for forming a customized cushioned grip on a handle. The cushioned grip of the invention can be formed on any stick or shaft for which a comfortable, tactile grip is desired. Examples of equipment for which the cushioned grip can be used include, but are not limited to, hockey sticks, lacrosse sticks, tennis rackets, baseball bats, axe handles, bicycle handlebars, sledge hammers, walking sticks, and canes. The user can build the grip over bare equipment (e.g., a wooden shaft, a metal handlebar) or over an existing grip.

Kits for customizing grips in accordance with the invention include one or more sheets of self-adhesive cushioning material and, optionally, tape, for example, color or white, cloth tape, friction tape, gauze tape, and self-adhesive tape. The cushioning material comes in a variety of shapes and patterns from which the user can choose to design the grip. After constructing a cushioning layer of these shapes, the user wraps the tape around the shaft over the shapes. These various shapes of the cushioning material stand through the tape, producing raised impressions. These raised impressions, in combination with the rough, tacky feel of the tape, improve the user's grasp of the grip. Further, the cushioning material makes the grip comfortable to grasp, and the cut-out-shaped raised impressions produce an aesthetically appealing appearance.

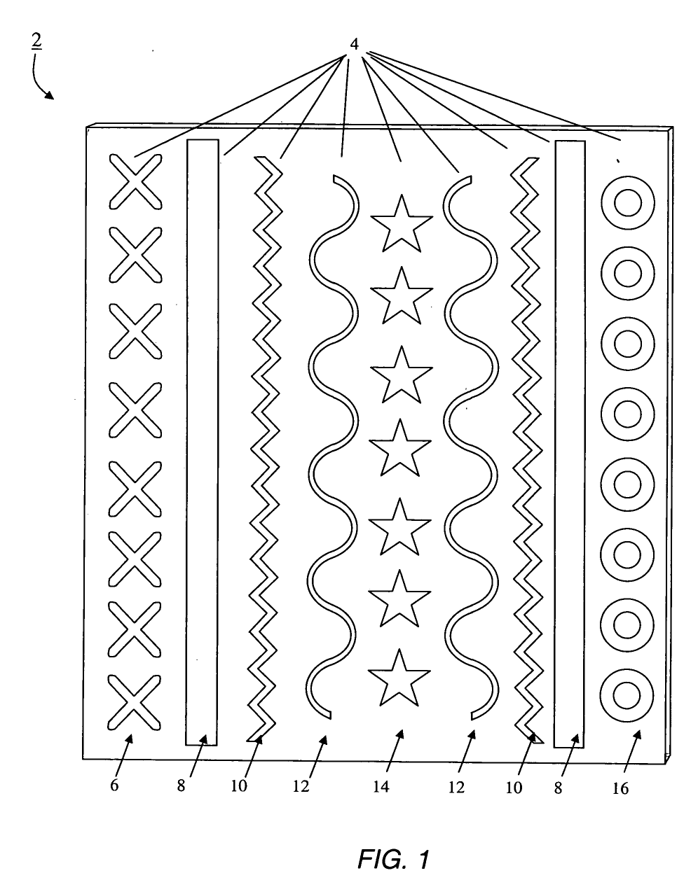

FIG. 1 shows an embodiment of a sheet 2 of a plurality of cut-outs 4 for use in customized construction of handle grips in accordance with the principles of the invention. In one embodiment, the sheet 2 is an 8 1/2 by 11 inch rectangular sheet of resilient, compressible material, such as closed or open cellular foam rubber, rubber, thermoplastic elastomer, and soft elastomeric gel. Other materials for producing resilient, compressible cut-outs can be used without departing from the principles of the invention. The thickness of the sheet 2 can vary based on user preference.

The resilient, compressible material has a pressure-sensitive adhesive backing. The strength of the adhesive can vary based on the particular application of the material. The sheet 2 has a paper backing to cover and protect the PSA backing of the material. When constructing a customized grip, the user separates each desired cut-out 4 from the paper backing to expose the adhesive on the back surface of the cut-out 4.

In the embodiment shown, the cut-outs 4 have various shapes or patterns: Xs 6, elongated rectangles 8, zigzags 10, curves 12, stars 14, and donuts 16. Sheets having fewer, more, or different shapes than those shown (e.g., circles, squares, polygons) can be used without departing from the principles of the invention. In this embodiment, each cut-out 4 is approximately 3/4 of an inch in width, and the lengths of the cut-outs 4 range from approximately 3/4 of an inch (Xs, stars, and donuts) to approximately 10 1/2 inches (rectangles, curves, and zigzags). The thickness of each cut-out 4 corresponds generally to the thickness of the sheet 2. These cut-out shapes are formed in the sheet 2 using any of a variety of techniques, including, but not limited to custom die-cut, laser-cut, water-jet, extruded, and molded processes.

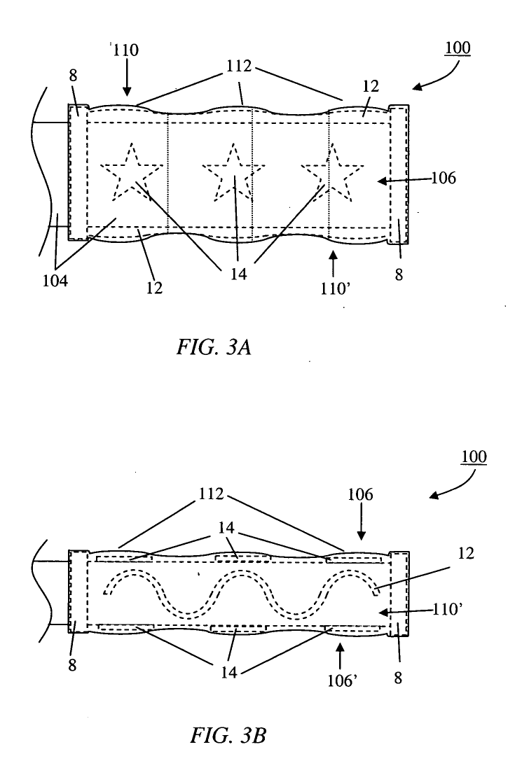

Various combinations of these differently shaped cut-outs 4 can be used in forming a grip. When adhered to a shaft or handle, each cut-out 4 operates to cushion the user's grip and produces a raised impression that helps keep the user's hand on the grip. Some shapes are preferably placed at certain places on the shaft or handle to provide a particular function. For example, the elongated rectangular cut-outs 8 define upper- and lower grip edges when wrapped around the stick shaft as shown below in connection with FIG. 3A and FIG. 3B. Other shapes, such as the Xs 6, zigzags 10, curves 12, stars 14, and donuts 16 have an additional aspect that is ornamental or decorative in effect.

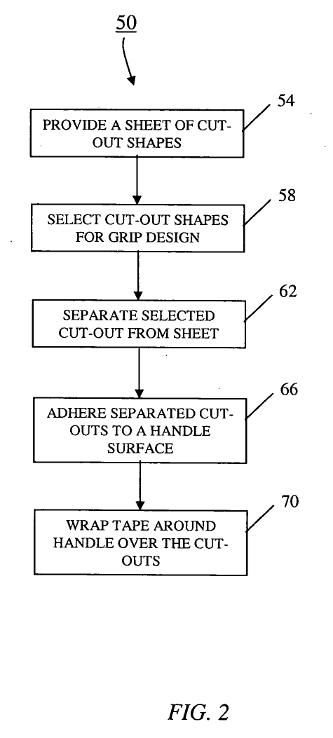

FIG. 2 shows an embodiment of a process 50 for constructing a custom grip in accordance with the principles of the invention. In the description of the process 50, reference is also made to FIG. 1. At step 54, the sheet 2 having the plurality of cut-outs 4 is provided (e.g., as part of a kit). The cut-outs 4 have various shapes. A user selects (step 58) particular shapes of cut-outs 4 to become part of the custom grip and separates (step 62) those cut-outs 4 from the paper backing of the sheet 2, to expose their adhesive backing. Each such cut-out 4 is adhered (step 66) to a surface of the handle at a desired location. Some shapes are wrapped around the handle, e.g., the rectangular shapes; others are adhered to the surface along a length of the handle.

At step 70, the user wraps tape around the handle over the cut-outs 4 adhered to the handle surfaces. The cut-outs 4 produce raised impressions under the tape, and the contours of the cut-outs 4 are clearly visible. Such raised impressions thus provide a customized ornamental appearance in addition to a tactile feel for a firm grasp of the handle.

FIG. 3A and FIG. 3B show an example of a custom-design grip 100 constructed in accordance with the invention. The grip 100 can be formed on a handle of a sports stick, such as a hockey stick, or on a handle of equipment, such as an axe handle. Here, the grip 100 is formed at the end of a shaft 104. That part of the shaft 104 wrapped in tape is shown in phantom. Phantom outlines for the various cut-outs shown in FIG. 3A and FIG. 3B indicate a cut-out-shaped raised impression formed in the tape.

Adhered to one side 106 of the shaft 104 is a plurality of star-shaped cut-outs 14. The star-shaped cut-outs 14 form raised impressions 112 shown in FIG. 3A. The opposite side (106′) of the shaft 104 can also have cut-outs adhered thereto. Rectangular-shaped cut-outs 8 wrap around the periphery of the shaft 104 at each end of the grip 100. Two side surfaces 110, 110′ of the shaft 104 have curve-shaped cut-outs 12 (see FIG. 3B) adhered thereto along a length of the grip 100. These curve-shaped cut-outs 12 also form raised impressions 112 in the grip 100, as shown in FIG. 3A.

Although the invention has been shown and described with reference to specific preferred embodiments, it should be understood by those skilled in the art that various changes in form and detail may be made therein without departing from the spirit and scope of the invention as defined by the following claims.

1. A method for forming a grip on a handle, the method comprising:
providing a cut-out made of resilient, compressible material and having an adhesive surface;
adhering the adhesive surface of the cut-out to a surface of the handle; and
wrapping tape around the handle over the cut-out to form a raised impression on the handle that has a shape of the cut-out.

2. The method of claim 1, further comprising providing a sheet of resilient, compressible material having the cut-out formed therein.

3. The method of claim 1, wherein the cut-out is rectangular in shape and wherein the step of adhering includes wrapping the rectangular cut-out around the handle to form a ridge at one end of the grip.

4. The method of claim 1, further comprising separating the cut-out from a sheet to expose adhesive on the surface of the cut-out.

5. The method of claim 1, selecting a plurality of differently shaped cut-outs from a sheet of resilient, compressible material and adhering each cut-out to a surface of the handle before wrapping the tape around the handle.

6. The method of claim 1, wherein a shape of the cut-out is of one of a star, a rectangle, a square, a circle, a donut, a zigzag, and a curve.

7. The method of claim 1, wherein the resilient, compressible material is cellular foam.

8. The method of claim 1, wherein the customized grip is for a hockey stick.

9. A system for making a customized grip on a handle, the system comprising:
a handle having a plurality of surfaces;
a plurality of differently shaped cut-outs of resilient, compressible material having an adhesive backing, the adhesive backing of each cut-out being adhered to one of the surfaces of the handle; and
a self-adhesive tape wrapped around the handle over the cut-outs of resilient, compressible material to produce a grip having compressible raised impressions in the shapes of the cut-outs.

10. The system of claim 9, further comprising a sheet of resilient, compressible material having the plurality of differently shaped cut-outs formed therein.

11. The system of claim 9, wherein one of the differently shaped cut-outs is rectangular and is wrapped around a periphery of the handle to form a ridge at an end of the grip.

12. The system of claim 9, wherein the plurality of differently shaped cut-outs includes one of a star, a rectangle, a square, a circle, a donut, a zigzag, and a curve.

13. The system of claim 9, wherein the resilient, compressible material is cellular foam.

14. The system of claim 9, wherein the customized grip is for a hockey stick.

15. A hockey stick having a handle, the hockey stick comprising:
a plurality of differently shaped cut-outs of resilient, compressible material adhered to at least one surface of the handle; and
tape wrapped spirally around the shaft over the cut-outs to produce a grip on the handle having resilient raised impressions in the shapes of the cut-outs.

16. The hockey stick of claim 15, wherein one of the differently shaped cut-outs is rectangular and is wrapped around a periphery of the handle to form a ridge at an end of the grip.

17. The hockey stick of claim 15, wherein the plurality of differently shaped cut-outs includes one of a star, a rectangle, a square, a circle, a donut, a zigzag, and a curve.

18. The hockey stick of claim 15, wherein the resilient, compressible material is cellular foam.
